(19) United States
(12) Patent Application Publication
(10) Pub. No.: US 2025/0386082 A1
(43) Pub. Date: Dec. 18, 2025

(54) AUTHORIZATION INTERMEDIARY TO REDUCE NETWORK TRAFFIC WITH AND PROCESSOR UTILIZATION OF A BACK-END AUTHORIZATION SYSTEM

(71) Applicant: Charter Communications Operating, LLC, St. Louis, MO (US)

(72) Inventors: Sarai Elaine Worsham, Littleton, CO (US); Jonathan Dain Huggins, Littleton, CO (US); Keith Thomas Neubert, Castle Rock, CO (US); Brad D. Stitt, Denver, CO (US)

(21) Appl. No.: 18/746,914

(22) Filed: Jun. 18, 2024

(51) Int. Cl. H04N 21/6334; H04N 21/231; H04N 21/258

(52) U.S. Cl. CPC H04N 21/6334; H04N 21/23106; H04N 21/25816

(57) ABSTRACT

An authorization intermediary determines that a content streaming application executing on a content streaming device has been authenticated to access at least a subset of content of a plurality of contents offered by a service provider. The authorization intermediary generates a token that is uniquely associated with the content streaming application. The authorization intermediary sends, to the content streaming application, the first token. The authorization intermediary subsequently receives from the content streaming application, a content authorization request to access a content of the plurality of contents, the content authorization request including the token. The authorization intermediary determines that the content authorization request is to be granted based on one of a content authorization cache maintained by the authorization intermediary and an approval from a front-end authorization system, and sends, to the content streaming application, information indicating that the content authorization request has been approved.

### BACKGROUND

In response to a user request to access streaming content, a content streaming application may seek authorization from a front-end authorization system that communicates with a service provider via which the user obtains content to determine whether the user has appropriate rights to view the requested content.

### SUMMARY

The examples disclosed herein implement an authorization intermediary that reduces network traffic and processor utilization of a back-end authorization system.

In one implementation a method is provided. The method includes determining, by an authorization intermediary executing on a computing system comprising one or more computing devices, that a first content streaming application executing on a first content streaming device has been authenticated to access at least a subset of content of a plurality of contents offered by a first service provider. The method further includes generating, by the authorization intermediary, a first token that is uniquely associated with the first content streaming application. The method further includes sending, by the authorization intermediary to the first content streaming application, the first token. The method further includes subsequently receiving, by the authorization intermediary from the first content streaming application, a first content authorization request to access a first content of the plurality of contents, the first content authorization request including the first token. The method further includes determining, by the authorization intermediary, that the first content authorization request is to be granted based on one of a content authorization cache maintained by the authorization intermediary and an approval from a front-end authorization system. The method further includes sending, by the authorization intermediary to the first content streaming application, information indicating that the first content authorization request has been approved.

In another implementation a computing system is provided. The computing system includes one or more computing devices operable to determine, by an authorization intermediary, that a first content streaming application executing on a first content streaming device has been authenticated to access at least a subset of content of a plurality of contents offered by a first service provider. The one or more computing devices are further operable to generate, by the authorization intermediary, a first token that is uniquely associated with the first content streaming application. The one or more computing devices are further operable to send, by the authorization intermediary to the first content streaming application, the first token. The one or more computing devices are further operable to subsequently receive, by the authorization intermediary from the first content streaming application, a first content authorization request to access a first content of the plurality of contents, the first content authorization request including the first token. The one or more computing devices are further operable to determine, by the authorization intermediary, that the first content authorization request is to be granted based on one of a content authorization cache maintained by the authorization intermediary and an approval from a front-end authorization system. The one or more computing devices are further operable to send, by the authorization intermediary to the first content streaming application, information indicating that the first content authorization request has been approved.

In another implementation a non-transitory computer-readable storage medium is provided. The non-transitory computer-readable storage medium includes executable instructions operable to cause one or more computing devices to determine, by an authorization intermediary, that a first content streaming application executing on a first content streaming device has been authenticated to access at least a subset of content of a plurality of contents offered by a first service provider. The instructions are further operable to cause the one or more computing devices to generate, by the authorization intermediary, a first token that is uniquely associated with the first content streaming application. The instructions are further operable to cause the one or more computing devices to send, by the authorization intermediary to the first content streaming application, the first token. The instructions are further operable to cause the one or more computing devices to subsequently receive, by the authorization intermediary from the first content streaming application, a first content authorization request to access a first content of the plurality of contents, the first content authorization request including the first token. The instructions are further operable to cause the one or more computing devices to determine, by the authorization intermediary, that the first content authorization request is to be granted based on one of a content authorization cache maintained by the authorization intermediary and an approval from a front-end authorization system. The instructions are further operable to cause the one or more computing devices to send, by the authorization intermediary to the first content streaming application, information indicating that the first content authorization request has been approved.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which an authorization intermediary to reduce network traffic with and processor utilization of a back-end authorization system can be implemented according to one example;

FIG. 2 is a flowchart of a method via which an authorization intermediary can reduce network traffic with and processor utilization of a back-end authorization system according to some implementations;

FIGS. 3A – 3B illustrate a sequence diagram illustrating actions taken by and messages communicated between components illustrated in FIG. 1 to implement an authorization intermediary to reduce network traffic with and processor utilization of a back-end authorization system according to some examples;

FIG. 4 is a block diagram of another environment in which an authorization intermediary to reduce network traffic with and processor utilization of a back-end authorization system can be implemented according to one example; and

FIG. 5 is a block diagram of a computing device suitable for implementing examples disclosed herein according to some implementations.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

A “connected television (CTV) application” is a content streaming application. In some implementations, a CTV application may be a TV Everywhere streaming application that allows an individual to watch a content “channel” (e.g., the AMC® channel) on different device platforms after authenticating with their television service provider (sometimes referred to herein as “service provider” for the sake of brevity). In some implementations, the channel may be one of a plurality of channels that are provided by the television service provider via a single content streaming application when the subscriber is at home. A content streaming application typically executes on a content streaming device, such as by way of non-limiting example, a computing device, a smartphone, a Roku® device, an Amazon® Fire Stick device, a Google® Chromecast® device, an Apple® AppleTV device, an Xbox® device, a smart TV that executes content streaming applications, or the like.

A content streaming application may require authentication prior to presenting streaming content. The particular mechanism for authentication may differ depending on the service provider, but essentially the authentication process determines whether the content streaming application is permitted to access content provided by a particular service provider. The authentication process may require, for example, a user to enter credentials, such as a user identifier and password or other suitable information via which it can be determined that the user is in fact a subscriber of the service provider. As used herein, it may be said that the authentication process authenticates the user, or the content streaming application or the content streaming device, since the authentication process involves determining that the user of the content streaming application on the content streaming device is a subscriber of the service provider.

Once authenticated, a content streaming application subsequently seeks authorization for a particular content. The term “content” as used herein refers to data that can be streamed, such as a movie, a television program, a live event, or the like, and presented on a display device. If the content streaming application is authorized to view the particular content based on the subscription of the user, the content streaming application is typically provided location information of the content, such as a URI or other information via which the content streaming application can access the content. The content streaming application then accesses the content and presents the content on a display device.

To facilitate communications between service providers and content streaming applications, front-end authentication and authorization systems (hereinafter front-end authorization systems for the sake of brevity) have been developed that standardize authentication and authorization communications between content providers and service providers and eliminates the need for each content streaming application to implement a proprietary authentication and authorization protocol with each potential service provider. A front-end authorization system publishes specifications for the content streaming applications (e.g., such as in the form of a representational state transfer application programming interface (REST API)) that, if implemented by the content streaming application, will enable the content streaming application to establish authentication and authorization communications with any service provider that has also agreed to utilize the front-end authorization system. Similarly the front-end authorization system publishes specifications for the service providers that, if implemented by the service provider, will enable the service provider to establish authentication and authorization communications with any content streaming application that has also agreed to utilize the front-end authorization system. Accordingly, many content streaming applications and service providers utilize a front-end authorization system. Many content streaming applications and service providers utilize a front-end authorization system such as, by way of non-limiting example, TotalCast (www.totalcast.com), although the examples are not limited to any particular front-end authorization system.

The front-end authorization system, during the authentication process, typically interacts with a service provider back-end authorization and authorization system (hereinafter back-end authorization system for the sake of brevity) to allow the service provider to request whatever authentication credentials are required. In some instances, the service provider may present their own login screen to acquire the requisite authentication credentials, and if the service provider determines that the user has provided the correct authentication credentials, informs the front-end authorization system that the client streaming application has been authenticated.

The front-end authorization system informs the content streaming application that the content streaming application has been authenticated. The content streaming application may then communicate with the front-end authorization system to determine whether the user is authorized to access the particular content requested by the user. For example, the subscription of the user may allow the user to view AMC but not HBO. The front-end authorization system again interacts with the service provider’s back-end authorization system to determine whether the content streaming application is authorized to view the content. The service provider’s back-end authorization system determines whether the subscription associated with the user allows the user to view the content. If so, the back-end authorization system informs the front-end authorization system that the content streaming application is authorized to access the content. The service provider may provide location information where the content streaming application can obtain the content. The front-end authorization system provides the location information to the content streaming application. The content streaming application accesses the content and presents the content on the display device.

Authorization requests can occur frequently and can cause substantial network traffic between the front-end authorization system and the back-end authorization system. Moreover, over time, the back-end authorization system can incur relatively substantial processor utilization repeatedly authorizing the same content with the same content streaming application. Additionally, each interaction with a front-end authorization system incurs additional processing, delay, and network usage. For these and other reasons, it is desirable to reduce the interactions with a front-end authorization system while still incurring the authentication and authorization benefits of a front-end authorization system.

Moreover, the disclosed embodiments delegating initial authorization and access to protected resources of a service provider to an external source, such as a front-end authorization system, and then enable subsequent authorizations to protected resources to be granted by an internal authorization intermediary.

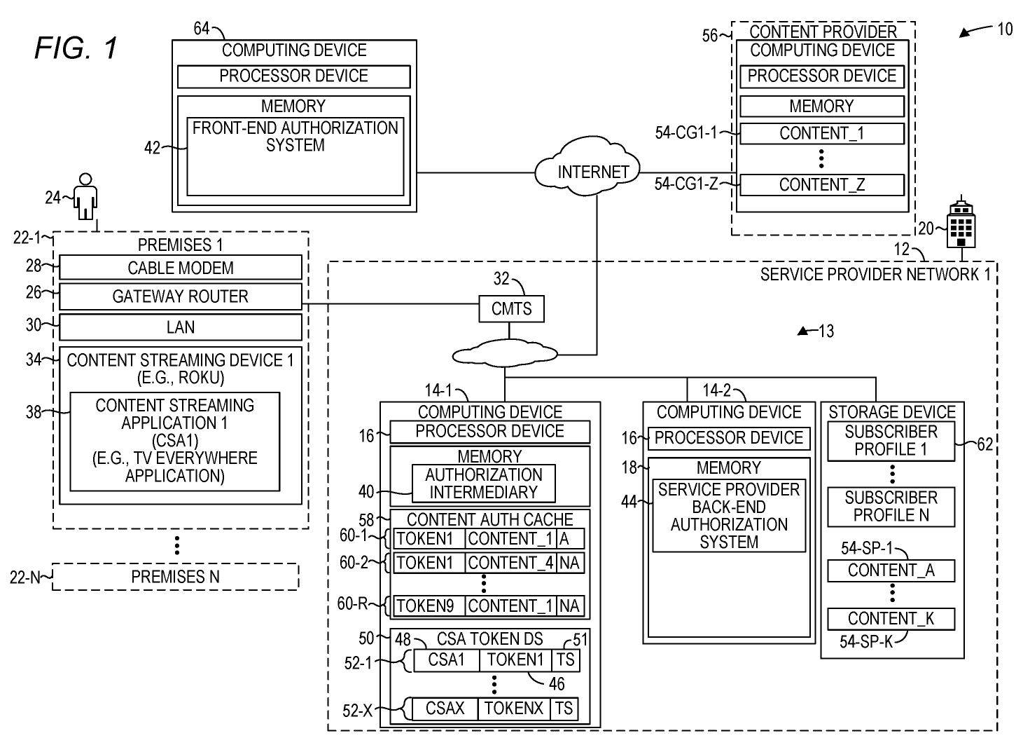

FIG. 1 is an environment 10 in which in which an authorization intermediary to reduce network traffic with and processor utilization of a back-end authorization system can be implemented. The environment 10 includes a service provider network 12 that includes a computing system 13 that in turn includes a plurality of computing devices 14-1 – 14-2 (generally, computing devices 14), each of which includes a processor device 16 and a memory 18. While solely for purposes of illustration various components will be illustrated as executing on the computing devices 14-1 – 14-2, it is noted that the components could execute in different operating environments including, by way of non-limiting example, virtual machine environments, cloud computing environments, or the like.

The service provider network 12 is operated by a service provider 20 that provides services to a plurality of premises 22-1 – 22-N (generally, premises 22). The services may include, by way of non-limiting example, broadband network access services and/or television subscription services. The service provider 20 may provide services to thousands, tens of thousands, or millions of different premises 22.

The premises 22-1 in this example is a residence, and the service provider 20 provides a user, such as a subscriber 24 associated with the premises 22-1 both broadband network access services (i.e., high-speed Internet access) and television subscription services. The services are provided in part via one or more CPE, including a gateway router 26 and a cable modem 28. The gateway router 26 implements a local area network (LAN) 30 in the premises 22-1 and communicates with other networks via the cable modem 28. The cable modem 28 is communicatively coupled to an aggregation device such as a cable modem termination system (CMTS) 32, which in turn is connected to other networking devices operated by the service provider 20 which collectively provide Internet connectivity to the gateway router 26 and devices connected to the LAN 30.

A content streaming device 34, in this example a Roku® content streaming device, is connected to the LAN 30 and to a TV 36. The content streaming device 34 may be a CTV device. The content streaming device 34 includes a content streaming application 38. The content streaming application 38 may be a TV Everywhere (TVE) streaming application (hereinafter a “TVE application” for the sake of brevity). TV Everywhere is a model and technology that allows subscribers, such as the subscriber 24, to view streaming content to which they subscribe on a broad spectrum of devices and platforms. TV Everywhere is an increasingly popular model for TV subscription providers because TV Everywhere allows a TV subscription provider to provide content streaming services in a manner similar to Over The Top (OTT) models, such as Netflix®.

The content streaming application 38 ensures, prior to streaming content, that the subscriber 24 has been properly authenticated by the service provider with which the subscriber 24 has a subscription, in this example, the service provider 20. The content streaming application 38 typically ensures that the subscriber 24 is authenticated every so often, such as each month, every two months, or the like. Once authenticated, the content streaming application 38 ensures that the subscriber 24 is authorized to view the content that the subscriber 24 has requested to view, because even though through the authentication process it was determined that the subscriber 24 is a subscriber of the service provider 20, the particular subscription of the subscriber 24 may allow the subscriber 24 to view only a subset of the content offered by the service provider 20. For example, the subscriber 24 may be able to view the AMC® channel but not the National Geographic® channel due to the particular subscription of the subscriber 24.

The content streaming application 38 may utilize any suitable mechanism for authenticating the subscriber 24. In some implementations, the content streaming application 38 may utilize a front-end authorization system 42, such as, by way of non-limiting example, the TotalCast front-end authorization system, to authenticate the subscriber 24. Some front-end authorization systems may involve a second screen application wherein the subscriber 24, during the authentication process, utilizes a second computing device, such as a smartphone, a laptop or desktop computing device, a tablet computing device, or the like, to enter authentication information for the particular service provider with which the subscriber has the relevant subscription. In practice, the front-end authorization system 42 sends a message to the content streaming application 38 that has a registration code and a URL that identifies the second screen application, typically a web page. The content streaming application 38 presents the registration code and the URL on a display device. The subscriber 24 enters the URL into the second computing device, enters the registration code, and selects the service provider 20 from a list of service providers. The subscriber 24 is then automatically redirected to a login web application of the service provider 20. The subscriber 24 enters their authentication credentials, and the service provider 20 authenticates the subscriber 24 (or does not). In other implementations, as will be discussed in greater detail below, the content streaming application 38 may be designed to communicate with an authorization intermediary 40 to authenticate with the service provider 20.

The content streaming device 34 is “behind” a CPE device, such as the cable modem 28 or the gateway router 26, provisioned by the service provider 20 to provide Internet access to the premises 22-1. Communications from the content streaming application 38 go through the cable modem 28 and the gateway router 26, and may contain information that can be used to identify the cable modem 28 and/or the gateway router 26, such as an IP address of the cable modem 28 or the gateway router 26, or the like. Because of this, one advantage of using the authorization intermediary 40 for authentication purposes rather than the front-end authorization system 42 is that the authorization intermediary 40 may be able to eliminate a second-screen application because the authorization intermediary 40 may be able to use such identifying information to determine that the content streaming application 38 is executing in a premises 22 to which the service provider 20 provides services, and thus may be able to be automatically authenticated.

With this background, an example of an authorization intermediary for reducing traffic with a front-end authorization system will now be discussed. Assume that the subscriber 24 desires to view content via the content streaming application 38, which, in this example, is a TV Everywhere content streaming application. The content streaming application 38 was originally developed to interface with the front-end authorization system 42, and has been modified to interoperate with the authorization intermediary 40. The subscriber 24 initiates the content streaming application 38 on the content streaming device 34. The content streaming application 38 determines that the subscriber 24 has not been authenticated, or has not been authenticated for a predetermined period of time, and thus initiates an authentication sequence. It is noted that, as used herein, authenticating the subscriber 24 is synonymous with authenticating the content streaming application 38 and the content streaming device 34. Thus, it may be said that the process described herein authenticates the subscriber 24, the content streaming application 38, and/or the content streaming device 34 since once authenticated, the subscriber 24 will be permitted to access at least some content offered by the service provider 20, subject to subsequent authorization.

The precise message sequence between the content streaming application 38 and the authorization intermediary 40 for authentication may differ depending on desired design. Generally, however, the content streaming application 38 invokes the authorization intermediary 40, and the authorization intermediary 40 invokes the front-end authorization system 42. The front-end authorization system 42 communicates with the back-end authorization system 44 of the service provider 20 to determine whether to authenticate the content streaming application 38. As discussed above, in some implementations this may involve the subscriber 24 being directed to use a second-screen application to enter suitable authentication credentials. Assume for purposes of illustration that the back-end authorization system 44 determines that the subscriber 24 is a subscriber of the service provider 20 and thus has a right to access at least some of the content offered by the service provider 20. The back-end authorization system 44 communicates information to the front-end authorization system 42 indicating that the content streaming application 38 is authenticated. The front-end authorization system 42 in turn communicates information to the authorization intermediary 40 indicating that the content streaming application 38 is authenticated.

The authorization intermediary 40 receives the information indicating that the content streaming application 38 is authenticated. In response, the authorization intermediary 40 generates a token 46 that is uniquely associated with the content streaming application 38. In one implementation, the authorization intermediary 40 stores the token 46 in association with a content streaming application identifier 48 that identifies the first content streaming application 38 in a data structure 50, and may include a timestamp 51 that identifies a time that the token 46 was generated. The content streaming application identifier 48 may comprise any suitable information that the content streaming application identifier 48 directly or indirectly (e.g., data that may be in the header of each message from the content streaming application identifier 48) provides to the authorization intermediary 40, such as an IP address, a MAC address, a generated unique identifier, or the like. The generated token may take any particular form. In some implementations, the generated token is a JSON web token (JWT).

The data structure 50 comprises a plurality of entries 52-1 – 52-X (generally, entries 52), each of which correlates a unique token with a particular content streaming application associated with a particular subscriber. Over time, the authorization intermediary 40 may generate thousands or millions of entries 52.

In another implementation, instead of maintaining the data structure 50 to subsequently validate the token, the token 46 itself may include metadata that can be subsequently processed, such as by decryption and/or other suitable algorithm(s), to determine whether the token 46 is valid.

The authorization intermediary 40 sends the token 46 to the content streaming application 38. The authorization intermediary 40 may also send information indicating that the content streaming application 38 has been authenticated, or alternatively, the sending of the token 46 may be sufficient to indicate that the content streaming application 38 has been authenticated.

The content streaming application 38 receives the token and stores the token. The content streaming application 38 will include the token in subsequent communications with the authorization intermediary 40. It is noted that content offered by the service provider 20 may be maintained by the service provider 20, such as contents 54-SP-1 – 54-SP-K. Content offered by the service provider 20 may also be maintained by another content generation entity, such as contents 54-CG1-1 – 54-CG1-Z maintained by a content generation entity 56. Content generation entities may be, by way of non-limiting example, AMC®, National Geographic®, or the like. Such content is offered by the service provider 20 via a contractual relationship with the content generation entity 56, but authorization to such contents from the subscriber 24 is defined by the subscription that the subscriber 24 has with the service provider 20. Contents 54-SP-1 – 54-SP-K and 54-CG1-1 – 54-CG1-Z may generally be referred to herein as contents 54.

The content streaming application 38 may then receive a request from the subscriber 24 to view a particular content 54 offered by the service provider 20. In this example, the request is to access the content 54-CG1-1 maintained by the content provider 56. The content streaming application 38 sends a content authorization request to access the content 54-CG1-1 to the authorization intermediary 40. The content authorization request includes the token 46 and an identifier of the content 54-CG1-1. The authorization intermediary 40 receives the content authorization request. The authorization intermediary 40 accesses the data structure 50 to confirm that the token 46 provided by the content streaming application 38 matches the token 46 previously generated by the authorization intermediary 40 for the content streaming application 38. Based on the entry 52-1, the authorization intermediary 40 determines that the token provided by the content streaming application 38 is the token 46 generated previously for the content streaming application 38, and thus that the content authorization request is a valid request.

The authorization intermediary 40 maintains a content authorization cache 58 that stores a plurality of entries 60-1 – 60-R, each of which identifies a particular content streaming application, a particular content, and an indication whether the particular content streaming application is authorized to access the particular content. For purposes of illustration, assume that at this instant in time the entry 60-1 is not in the content authorization cache 58. In response to determining that the content authorization cache 58 lacks an entry corresponding to the content streaming application 38 and the content 54-CG1-1, the authorization intermediary 40 sends a request to the front-end authorization system 42 requesting authorization for the content streaming application 38 to access the content 54-CG1-1.

The front-end authorization system 42 receives the request, and communicates with the back-end authorization system 44 of the service provider network 12. The back-end authorization system 44 accesses a subscriber profile 62 associated with the subscriber 24 and determines that the subscription of the subscriber 24 allows the subscriber 24 to access the content 54-CG1-1. The back-end authorization system 44 communicates information to the front-end authorization system 42 indicating that the subscriber 24 has the appropriate rights to view the content 54-CG1-1. The front-end authorization system 42 sends an approval message to the authorization intermediary 40 indicating that the subscriber 24 has the appropriate rights to view the content 54-CG1-1.

The authorization intermediary 40 determines based on the approval that the content authorization request received from the content streaming application 38 is to be granted. The authorization intermediary 40 stores, in the content authorization cache 58, authorization information that authorizes the content streaming application 38 to access the content 54-CG1-1. While the form of authorization information may vary, in this implementation the authorization information comprises the entry 60-1 which includes information that corresponds to the content streaming application 38, in this example, the token 46, a content identifier that identifies the content 54-CG1-1, and a flag indicating that the content streaming application 38 is authorized to view the content 54-CG1-1 (e.g., “A”).

The authorization intermediary 40 sends information to the content streaming application 38 indicating that the content authorization request has been approved. In one implementation, the information may comprise location information, such as a URI, of the content 54-CG1-1 that allows the content streaming application 38 to access and stream the content 54-CG1-1 on the TV 36.

Assume for purposes of illustration that at a later point in time, the subscriber 24 again requests to access the content 54-CG1-1. The content streaming application 38 sends a content authorization request to access the content 54-CG1-1 to the authorization intermediary 40. The content authorization request includes the token 46 and an identifier of the content 54-CG1-1. The authorization intermediary 40 receives the content authorization request. The authorization intermediary 40 accesses the data structure 50 to confirm that the token 46 provided by the content streaming application 38 matches the token 46 previously generated by the authorization intermediary 40 for the content streaming application 38. Based on the entry 52-1, the authorization intermediary 40 determines that the token provided by the content streaming application 38 is the token 46 generated previously for the content streaming application 38, and thus that the content authorization request is a valid request.

The authorization intermediary 40 accesses and searches the content authorization cache 58. The authorization intermediary 40 locates the entry 60-1, and based on the entry 60-1, the authorization intermediary 40 determines that the content authorization request is to be granted. The authorization intermediary 40 sends the URI of the content 54-CG1-1 to the content streaming application 38 to indicate that the content authorization request is granted. Note that, because the entry 60-1 was in the content authorization cache 58, the authorization intermediary 40 did not communicate with the front-end authorization system 42. Moreover, because there is no need to communicate with the front-end authorization system 42, there were no communications between the front-end authorization system 42 and the back-end authorization system 44, reducing network usage and processor utilization of both the front-end authorization system 42 and the back-end authorization system 44.

It is noted that the front-end authorization system 42 may execute on a computing device in the service provider network 12, or, in an alternative implementation as illustrated in FIG. 1, may execute on a computing device 64 that is located outside of the service provider network 12. In some implementations, the computing device 64 may be operated by the manufacturer of the front-end authorization system 42.

It is also noted that, although the authorization intermediary 40 is illustrated as a single component executing on a single computing device of the computing system 13, in other implementations the functionality attributed herein to the authorization intermediary 40 may be implemented in multiple components distributed across one or more computing devices of the computing system 13.

It is further noted that, because the authorization intermediary 40 is a component of the computing system 13, functionality implemented by the authorization intermediary 40 may be attributed to the computing system 13. Moreover, in examples where the authorization intermediary 40 comprises software instructions that program the processor devices 16 to carry out functionality discussed herein, functionality implemented by the authorization intermediary 40 may be attributed herein to the processor devices 16.

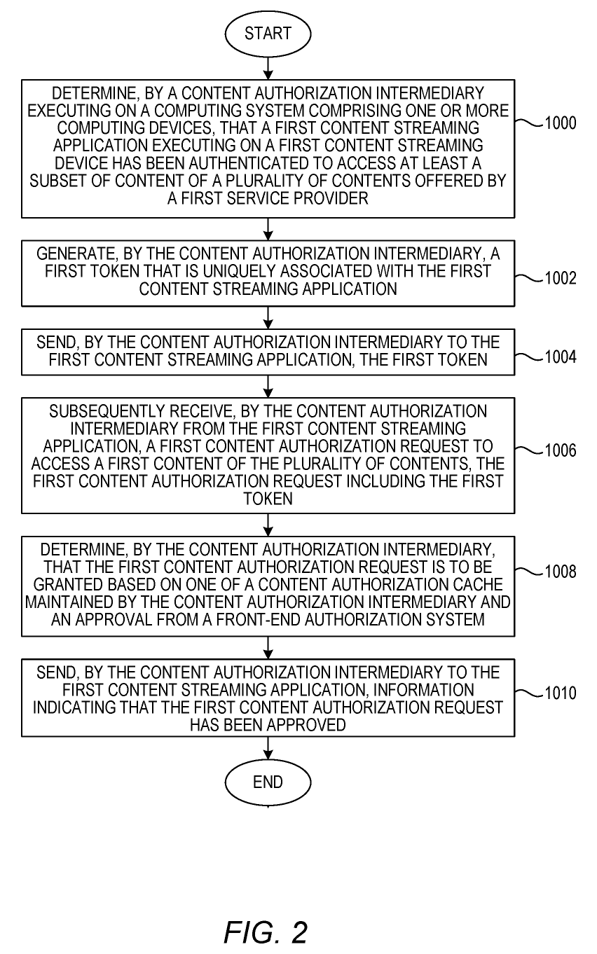

FIG. 2 is a flowchart of a method via which an authorization intermediary can reduce traffic with a front-end authorization system according to some implementations. FIG. 2 will be discussed in conjunction with FIG. 1. The authorization intermediary 40, executing on the computing system 13 comprising the one or more computing devices 14, determines that the content streaming application 38 executing on the content streaming device 34 has been authenticated to access at least a subset of content 54 of a plurality of contents 54 offered by the service provider 20 (FIG. 2, block 1000). The authorization intermediary 40 generates the token 46 that is uniquely associated with the content streaming application 38 (FIG. 2, block 1002). The authorization intermediary 40 sends, to the content streaming application 38, the token 46 (FIG. 2, block 1004). The authorization intermediary 40 subsequently receives, from the content streaming application 38, a content authorization request to access the content 54-CG1-1 of the plurality of contents 54, the content authorization request including the token 46 (FIG. 2, block 1006). The authorization intermediary 40 determines that the content authorization request is to be granted based on one of the content authorization cache 58 maintained by the authorization intermediary 40 and an approval from the front-end authorization system 42 (FIG. 2, block 1008). The authorization intermediary 40 sends, to the content streaming application 38, information indicating that the content authorization request has been approved (FIG. 2, block 1010).

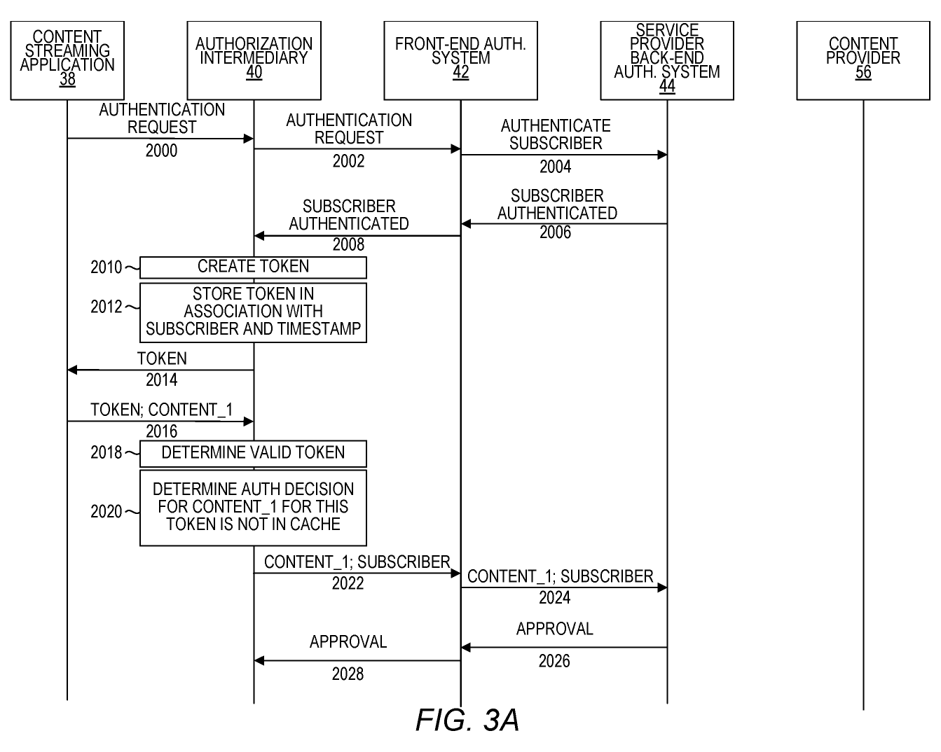

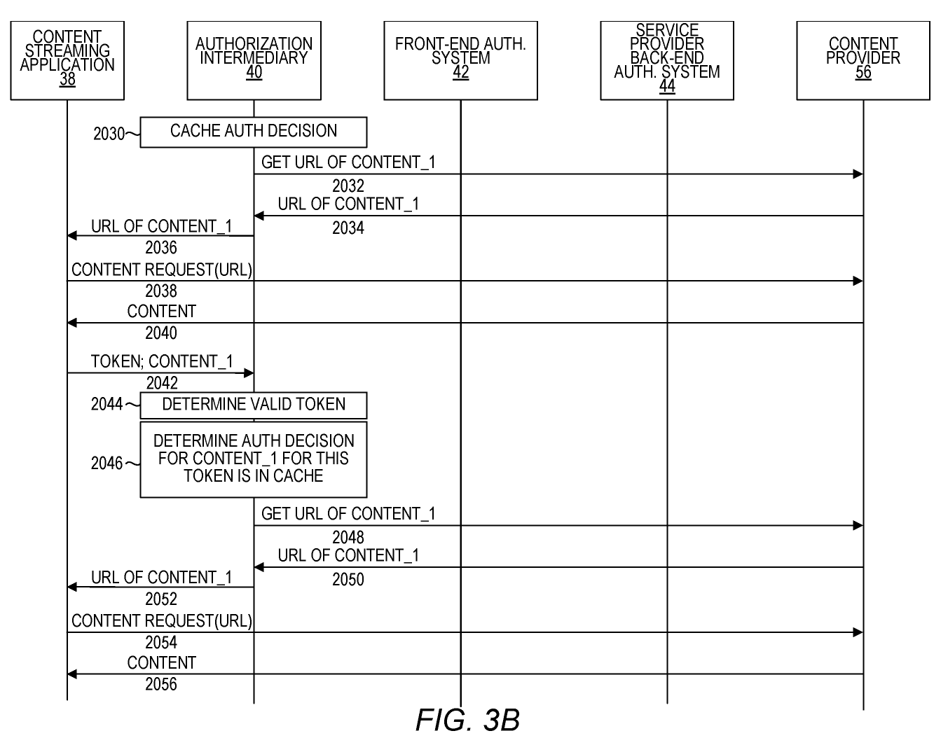

FIGS. 3A – 3B illustrate a sequence diagram illustrating actions taken by and messages communicated between components illustrated in FIG. 1 according to one implementation. In response to user input from the subscriber 24, the content streaming application 38 sends an authentication request message to the authorization intermediary 40 (FIG. 3A, step 2000). The authentication request message includes information either in the body or the header of the message via which the subscriber 24 can be identified. As an example, the authentication request message may contain an identifier of the subscriber 24, or may include an IP address or other device identifier that is known to be associated with the subscriber 24. The authorization intermediary 40 forwards an authentication request based on the authentication request message to the front-end authorization system 42 (FIG. 3A, step 2002). The front-end authorization system 42 sends a message to the back-end authorization system 44 of the service provider 20 to determine if the subscriber 24 is a subscriber of the service provider 20 (FIG. 3A, step 2004). The back-end authorization system 44 accesses subscriber information and determines that the subscriber 24 is a subscriber of the service provider 20 and is thus authenticated. Although not illustrated, the authentication process may, in some implementations, involve the back-end authorization system 44 requesting authentication credentials from the subscriber 24. The back-end authorization system 44 informs the front-end authorization system 42 that the subscriber 24 is authenticated (FIG. 3A, step 2006). The front-end authorization system 42 sends an authentication approval to the authorization intermediary 40 indicating that the subscriber 24 is authenticated (FIG. 3A, step 2008).

In response to the subscriber 24 being authenticated, the authorization intermediary 40 generates the token 46 that is uniquely associated with the subscriber 24 (FIG. 3A, step 2010). The authorization intermediary 40 generates the entry 52-1 that includes the token 46, information that corresponds to the subscriber 24, in this example, the content streaming application identifier 48 that identifies the first content streaming application 38, and the timestamp 51, and stores the entry 52-1 in the data structure 50 (FIG. 3A, step 2012). The authorization intermediary 40 sends information to the content streaming application 38 indicating that the content streaming application 38 is authenticated, the information including the token 46 (FIG. 3A, step 2014). As noted above, because the subscriber 24, the content streaming application 38 and the content streaming device 34 all correspond to one another, authentication of the subscriber 24 can be viewed as authentication of each of the subscriber 24, the content streaming application 38 and the content streaming device 34.

Subsequently, the content streaming application 38 sends a content authorization request to access content, such as the content 54-CG1-1, that includes the token 46 (FIG. 3A, step 2016). The authorization intermediary 40 receives the content authorization request. The authorization intermediary 40 determines whether the token 46 is a valid token. The authorization intermediary 40 may analyze a format or syntax of the token 46 to ensure it complies with the format or syntax of a valid token. If so, the authorization intermediary 40 may then access the data structure 50 and determine that the token 46 is associated with the content streaming application 38, and is thus a valid and correct token (FIG. 3A, step 2018).

The authorization intermediary 40 then accesses the content authorization cache 58. Assume for purposes of illustration that the entry 60-1 has not yet been generated by the authorization intermediary 40. The authorization intermediary 40 determines that the content authorization cache 58 lacks valid authorization information that authorizes the content streaming application 38 to access the content 54-CG1-1 (FIG. 3A, step 2020). In response to determining that the content authorization cache 58 lacks the valid authorization information that authorizes the content streaming application 38 to access the content 54-CG1-1, the authorization intermediary 40 sends, to the front-end authorization system 42, information identifying the content authorization request (FIG. 3A, step 2022). The information may include, for example, information that identifies the subscriber 24 and information that identifies the content 54-CG1-1.

The front-end authorization system 42 sends a message to the back-end authorization system 44 to determine whether the subscriber 24 is authorized to access the content 54-CG1-1 (FIG. 3A, step 2024). The back-end authorization system 44 accesses the subscriber profile 62 and determines that the subscriber 24 is authorized to access the content 54-CG1-1. The back-end authorization system 44 sends an approval message to the front-end authorization system 42 (FIG. 3A, step 2026). The front-end authorization system 42 sends an approval to the authorization intermediary 40 (FIG. 3A, step 2028).

Referring now to FIG. 3B, the authorization intermediary 40 stores, in the content authorization cache 58, authorization information in the form of the entry 60-1 that authorizes the content streaming application 38 to access the content 54-CG1-1 (FIG. 3B, step 2030). The authorization intermediary 40 may obtain location information that identifies a location of the content 54-CG1-1, such as, by way of non-limiting example, a URI of the content 54-CG1-1, or a manifest associated with the content 54-CG1-1. In one implementation, the authorization intermediary 40 may send a request to the content provider 56 for the location information (FIG. 3B, step 2032). The content provider 56 sends the location information to the authorization intermediary 40 (FIG. 3B, step 2034).

The authorization intermediary 40 sends the location information to the content streaming application 38 indicating that the content authorization request has been approved (FIG. 3B, step 2036). The content streaming application 38 may then access the content 54-CG1-1 and begin streaming the content 54-CG1-1 (FIG. 3B, steps 2038-2040).

Subsequently, such as an hour, day or a week later, the subscriber 24 seeks to again view the content 54-CG1-1. For example, the subscriber 24 may have initially only viewed a portion of the content 54-CG1-1 and now seeks to view the remainder of the content 54-CG1-1. The subscriber 24 interacts with the content streaming application 38 and requests to view the content 54-CG1-1. The previous authentication of the content streaming application 38 may last for some predetermined amount of time, such as weeks or months, and thus the content streaming application 38 may not need to re-authenticate. The content streaming application 38 sends a content authorization request to access the content 54-CG1-1 that includes the token 46 (FIG. 3B, step 2042). The authorization intermediary 40 receives the content authorization request. The authorization intermediary 40 determines that the token 46 is a valid token (FIG. 3B, step 2044). The authorization intermediary 40 then accesses the content authorization cache 58 and determines, based on the authorization information in the form of the entry 60-1 that authorizes the content streaming application 38 to access the content 54-CG1-1, that the content streaming application 38 is authorized to access the content 54-CG1-1 (FIG. 3B, step 2046). Because the authorization information is in the content authorization cache 58, the authorization intermediary 40 need not communicate with the front-end authorization system 42, which eliminates the communications between the front-end authorization system 42 and the back-end authorization system 44 that would otherwise occur, reducing network usage and processor utilization of both the front-end authorization system 42 and the back-end authorization system 44.

The authorization intermediary 40 sends a request to the content provider 56 for the location information (FIG. 3B, step 2048). The content provider 56 sends the location information to the authorization intermediary 40 (FIG. 3B, step 2050). The authorization intermediary 40 sends the location information to the content streaming application 38 indicating that the content authorization request has been approved (FIG. 3B, step 2052). The content streaming application 38 may then access the content 54-CG1-1 and begin streaming the content 54-CG1-1 (FIG. 3B, steps 2054-2056).

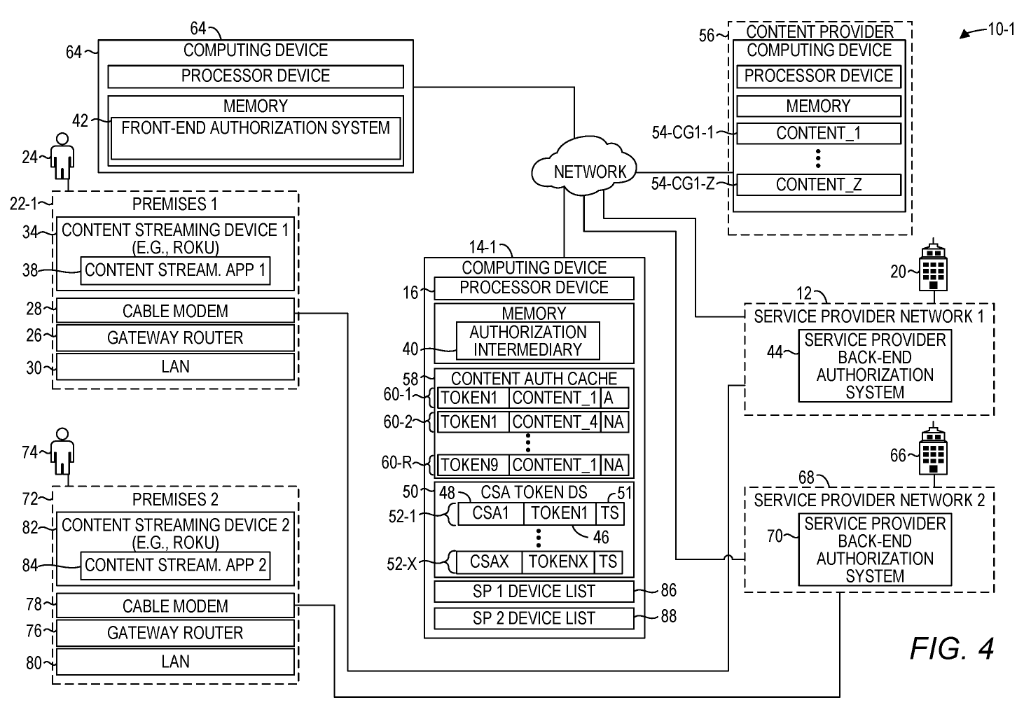

FIG. 4 is a block diagram of an environment 10-1 according to another implementation. The environment 10-1 is substantially similar to the environment 10 except as otherwise described herein. It is noted that certain elements not relevant to the discussion herein have been omitted from FIG. 4 due to spatial limitations, however, each of the elements bearing the same element reference numeral as that in FIG. 1 contain the same components illustrated in FIG. 1. The environment 10-1 includes the first service provider 20 and a second service provider 66. The second service provider 66 includes a service provider network 68 that includes substantially similar components as those discussed above with regard to the service provider network 12 illustrated in FIG. 1. The service provider network 68 includes a back-end authorization system 70 that provides similar or identical functionality as the back-end authorization system 44. In particular, the back-end authorization system 70 is operable to authenticate subscribers that subscribe to the second service provider 66 to obtain content streaming services and is also operable to authorize contents offered by the second service provider 66.

The service provider network 68 provides services to a plurality of premises, including a premises 72. The services may include, by way of non-limiting example, broadband network access services and/or television subscription services. The service provider 66 may provide services to thousands, tens of thousands, or millions of different premises.

The premises 72 in this example is a residence, and the service provider 66 provides a user, such as a subscriber 74 associated with the premises 72 both broadband network access services (i.e., high-speed Internet access) and television subscription services. The services are provided in part via one or more CPE, including a gateway router 76 and a cable modem 78. The gateway router 76 implements a local area network (LAN) 80 in the premises 72 and communicates with other networks via the cable modem 78. The cable modem 78 is communicatively coupled to an aggregation device such as a CMTS (not illustrated), which in turn is connected to other networking devices operated by the service provider 66 which collectively provide Internet connectivity to the gateway router 76 and devices connected to the LAN 30.

A content streaming device 82 is connected to the LAN 80. The content streaming device 82 may be a CTV device. The content streaming device 82 includes a content streaming application 84. The content streaming application 84 may be a TVE streaming application.

In this implementation the computing device 14-1 may be part of the service provider network 12, or may be separate from the service provider network 12. In either case, the service provider network 12 and the service provider network 68 are communicatively coupled to the computing device 14-1. In this example, the authorization intermediary 40 provides authorization services, as described above with regard to FIG. 1, to both the service provider 20 and the service provider 66. As an example, assume that the subscriber 24 desires to view streaming content via the content streaming application 38. The subscriber 24 initiates the content streaming application 38 on the content streaming device 34. The content streaming application 38 determines that the subscriber 24 has not been authenticated, or has not been authenticated for a predetermined period of time, and thus initiates an authentication sequence.

The content streaming application 38 makes an authentication request by invoking an entry point of the authorization intermediary 40. In this example, the authorization intermediary 40 initially determines that the content streaming device 34 is associated with the service provider 20. The authorization intermediary 40 may make this determination in any suitable manner. In one implementation, the authorization intermediary 40 may extract information included in the authentication request, such as an IP address of the gateway router 26 or cable modem 28. The authorization intermediary 40 may then query the service provider network 12 requesting confirmation that the IP address is an IP address associated with the service provider 20. If the service provider network 12 indicates that the IP address is not associated with the service provider 20, the authorization intermediary 40 may then query the service provider network 68 requesting confirmation that the IP address is an IP address associated with the service provider 66.

In another implementation, the authentication request may include a service provider indicator that identifies the particular service provider. In another implementation, the token 46 may be generated to include information from which the particular service provider can be identified. In another implementation, the service provider 20 may provide a list 86 of identifiers, such as IP addresses of gateway routers, cable modems, or any other suitable identifiers, that correspond to devices provided or provisioned by the service provider 20 to subscribers of the service provider 20. Similarly, the service provider 66 may provide a list 88 of identifiers, such as IP addresses of gateway routers, cable modems, or any other suitable identifiers, that correspond to devices provided or provisioned by the service provider 66 to subscribers of the service provider 66.

In this example, the authorization intermediary 40 accesses the list 86 and determines that the IP address extracted from the authentication message is on the list 86, and thus that the content streaming application 38 is associated with the service provider 20. The authorization intermediary 40 invokes the front-end authorization system 42 passing information from the authentication message to the front-end authorization system 42 and information indicating that the authentication message is associated with a subscriber of the service provider 20. The front-end authorization system 42 communicates with the back-end authorization system 44 of the service provider 20 to determine whether the content streaming application 38 is authenticated, as discussed above with regard to FIG. 1. Assume that the content streaming application 38 is successfully authenticated. As discussed above, the authorization intermediary 40 generates the token 46 that is uniquely associated with the content streaming application 38. The authorization intermediary 40 stores the token 46 in association with the content streaming application identifier 48 that identifies the content streaming application 38 in the data structure 50, and may include the timestamp 51 that identifies the time that the token 46 was generated.

The authorization intermediary 40 sends the token 46 to the content streaming application 38. The authorization intermediary 40 may also send information indicating that the content streaming application 38 has been authenticated, or alternatively, the sending of the token 46 may be sufficient to indicate that the content streaming application 38 has been authenticated.

The content streaming application 38 may then receive a request from the subscriber 24 to view a particular content 54 offered by the service provider 20. In this example, the request is to access the content 54-CG1-1 maintained by the content provider 56. The content streaming application 38 sends a content authorization request to access the content 54-CG1-1 to the authorization intermediary 40. The content authorization request includes the token 46 and an identifier of the content 54-CG1-1. The authorization intermediary 40 receives the content authorization request. The authorization intermediary 40 accesses the data structure 50 to confirm that the token 46 provided by the content streaming application 38 matches the token 46 previously generated by the authorization intermediary 40 for the content streaming application 38. Based on the entry 52-1, the authorization intermediary 40 determines that the token provided by the content streaming application 38 is the token 46 generated previously for the content streaming application 38, and thus that the content authorization request is a valid request.

For purposes of illustration, assume that at this instant in time the entry 60-1 is not in the content authorization cache 58. In response to determining that the content authorization cache 58 lacks an entry corresponding to the content streaming application 38 and the content 54-CG1-1, the authorization intermediary 40 sends a request to the front-end authorization system 42 requesting authorization for the content streaming application 38 to access the content 54-CG1-1. The authorization intermediary 40 includes information in the request to the front-end authorization system 42 indicating that the request is associated with the service provider 20. The authorization intermediary 40 may make this determination as discussed above, such as by querying the service provider 20, or the list 86, or the authorization intermediary 40 may store information in the entry 52-1 indicating that the content streaming application 38 is associated with the service provider 20. Authorization then proceeds as discussed above, and the front-end authorization system 42 sends an approval message to the authorization intermediary 40 indicating that the subscriber 24 has the appropriate rights to view the content 54-CG1-1.

The authorization intermediary 40 determines based on the approval that the content authorization request received from the content streaming application 38 is to be granted. The authorization intermediary 40 stores, in the content authorization cache 58, the entry 60-1 which includes information that identifies the content streaming application 38, in this example, the token 46, a content identifier that identifies the content 54-CG1-1, and a flag indicating that the content streaming application 38 is approved to view the content 54-CG1-1 (e.g., “A”).

The authorization intermediary 40 sends information to the content streaming application 38 indicating that the content authorization request has been approved. In one implementation, the information may comprise location information, such as a URI, of the content 54-CG1-1 that allows the content streaming application 38 to access and stream the content 54-CG1-1 on the TV 36.

The same authentication and authorization process may be implemented for the content streaming application 84, except the authorization intermediary 40 determines that the content streaming application 84 is associated with the service provider 66 rather than the service provider 20, and thus provides information to the front-end authorization system 42 that causes the front-end authorization system 42 to authenticate and authorize the content streaming application 84 with the back-end authorization system 70 rather than the back-end authorization system 44.

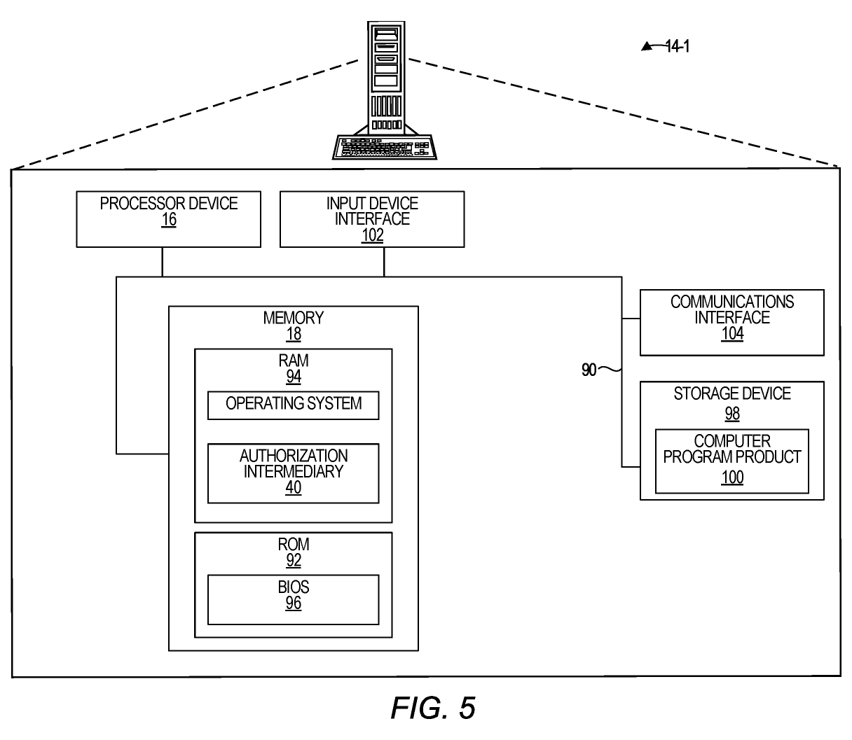

FIG. 5 is a block diagram of a computing device suitable for implementing examples disclosed herein according to some implementations. The computing device 14-1 may comprise any computing or electronic device capable of including firmware, hardware, and/or executing software instructions to implement the functionality described herein, such as a computer server, a desktop computing device, a special purpose network processing device or the like. The computing device 14-1 includes the processor device 16, the system memory 18, and a system bus 90. The system bus 90 provides an interface for system components including, but not limited to, the system memory 18 and the processor device 16. The processor device 16 can be any commercially available or proprietary processor.

The system bus 90 may be any of several types of bus structures that may further interconnect to a memory bus (with or without a memory controller), a peripheral bus, and/or a local bus using any of a variety of commercially available bus architectures. The system memory 18 may include non-volatile memory 92 (e.g., read-only memory (ROM), erasable programmable read-only memory (EPROM), electrically erasable programmable read-only memory (EEPROM), etc.), and volatile memory 94 (e.g., random-access memory (RAM)). A basic input/output system (BIOS) 96 may be stored in the non-volatile memory 92 and can include the basic routines that help to transfer information between elements within the computing device 14-1. The volatile memory 94 may also include a high-speed RAM, such as static RAM, for caching data.

The computing device 14-1 may further include or be coupled to a non-transitory computer-readable storage medium such as a storage device 98, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 98 and other drives associated with computer-readable media and computer-usable media may provide non-volatile storage of data, data structures, computer-executable instructions, and the like.

A number of modules can be stored in the storage device 98 and in the volatile memory 94, including an operating system and one or more program modules, such as the authorization intermediary 40, which may implement the functionality described herein in whole or in part. All or a portion of the examples may be implemented as a computer program product 100 stored on a transitory or non-transitory computer-usable or computer-readable storage medium, such as the storage device 98, which includes complex programming instructions, such as complex computer-readable program code, to cause the processor device 16 to carry out the steps described herein. Thus, the computer-readable program code can comprise software instructions for implementing the functionality of the examples described herein when executed on the processor device 16. The processor device 16, in conjunction with the authorization intermediary 40 in the volatile memory 94, may serve as a controller, or control system, for the computing device 14-1 that is to implement the functionality described herein.

An operator may also be able to enter one or more configuration commands through a keyboard (not illustrated), a pointing device such as a mouse (not illustrated), or a touch-sensitive surface such as a display device. Such input devices may be connected to the processor device 16 through an input device interface 102 that is coupled to the system bus 90 but can be connected by other interfaces such as a parallel port, an Institute of Electrical and Electronic Engineers (IEEE) 1394 serial port, a Universal Serial Bus (USB) port, an IR interface, and the like. The computing device 14-1 may also include a communications interface 104 suitable for communicating with a network as appropriate or desired.

Individuals will recognize improvements and modifications to the preferred examples of the disclosure. All such improvements and modifications are considered within the scope of the concepts disclosed herein and the claims that follow.

What is claimed is:

1. A method, comprising:
determining, by an authorization intermediary executing on a computing system comprising one or more computing devices, that a first content streaming application executing on a first content streaming device has been authenticated to access at least a subset of content of a plurality of contents offered by a first service provider;
generating, by the authorization intermediary, a first token that is uniquely associated with the first content streaming application;
sending, by the authorization intermediary to the first content streaming application, the first token;
subsequently receiving, by the authorization intermediary from the first content streaming application, a first content authorization request to access a first content of the plurality of contents, the first content authorization request including the first token;
determining, by the authorization intermediary, that the first content authorization request is to be granted based on one of a presence of an entry associated with the first content within a content authorization cache maintained by the authorization intermediary and an approval from a front-end authorization system; and
sending, by the authorization intermediary to the first content streaming application, information indicating that the first content authorization request has been approved.

2. The method of claim 1, wherein determining that the first content streaming application has been authenticated to access the at least the subset of content of the plurality of contents offered by the first service provider further comprises:
receiving, by the authorization intermediary from the first content streaming application, an authentication request;
sending, by the authorization intermediary to the front-end authorization system, the authentication request;
receiving, by the authorization intermediary from the front-end authorization system, an authentication approval; and
sending, by the authorization intermediary to the first content streaming application, information indicating that the first content streaming application is authenticated.

3. The method of claim 1, further comprising storing, in a data structure, the first token in association with a first content streaming application identifier.

4. The method of claim 1, wherein determining, by the authorization intermediary, that the first content authorization request is to be granted based on one of the presence of the entry associated with the first content within the content authorization cache maintained by the authorization intermediary and the approval from the front-end authorization system further comprises:
accessing, by the authorization intermediary, the content authorization cache;
determining, by the authorization intermediary, that the content authorization cache lacks valid authorization information that authorizes the first content streaming application to access the first content;
in response to determining that the content authorization cache lacks the valid authorization information that authorizes the first content streaming application to access the first content, sending, by the authorization intermediary to the front-end authorization system, information identifying the first content authorization request; and
receiving, by the authorization intermediary from the front-end authorization system, the approval.

5. The method of claim 4, further comprising:
storing, by the authorization intermediary in the content authorization cache, authorization information that authorizes the first content streaming application to access the first content;
subsequently receiving, by the authorization intermediary from the first content streaming application, a second content authorization request to access the first content, the second content authorization request including the first token;
accessing, by the authorization intermediary, the content authorization cache; and
determining, based on the authorization information that authorizes the first content streaming application to access the first content, that the first content streaming application is authorized to access the first content.

6. The method of claim 1, further comprising:
prior to determining, by the authorization intermediary, that the first content authorization request is to be granted based on one of the presence of the entry associated with the first content within the content authorization cache maintained by the authorization intermediary and the approval from the front-end authorization system, validating, by the authorization intermediary, the first token to determine that the first token is a valid token.

7. The method of claim 1, further comprising:
determining, by the authorization intermediary, that the first content streaming device is associated with the first service provider of a plurality of service providers.

8. The method of claim 7, wherein determining, by the authorization intermediary, that the first content streaming device is associated with the first service provider of the plurality of service providers comprises:
determining, by the authorization intermediary, an identifier that corresponds to the first content streaming device;
accessing a first list of a plurality of identifiers associated with the first service provider, the first list being one of a plurality of lists of identifiers maintained by the authorization intermediary, each list of identifiers being associated with a different service provider; and
determining, by the authorization intermediary, that the identifier is on the first list.

9. The method of claim 1, further comprising:
determining, by the authorization intermediary, that a second content streaming application executing on a second content streaming device has been authenticated to access at least a subset of content of a plurality of contents offered by a second service provider;
generating, by the authorization intermediary, a second token that is uniquely associated with the second content streaming application;
sending, by the authorization intermediary to the second content streaming application, the second token;
subsequently receiving, by the authorization intermediary from the second content streaming application, a second content authorization request to access a second content of the plurality of contents offered by a second service provider, the second content authorization request including the second token;
determining, by the authorization intermediary, that the second content authorization request is to be granted based on one of a presence of an entry associated with the second content within the content authorization cache maintained by the authorization intermediary and an approval from the front-end authorization system; and
sending, by the authorization intermediary to the second content streaming application, information indicating that the second content authorization request has been approved.

10. The method of claim 9, wherein determining, by the authorization intermediary, that the second content authorization request is to be granted based on one of the presence of the entry associated with the second content within the content authorization cache maintained by the authorization intermediary and the approval from the front-end authorization system further comprises:
accessing, by the authorization intermediary, the content authorization cache;
determining, by the authorization intermediary, that the content authorization cache lacks valid authorization information that authorizes the second content streaming application to access the second content;
in response to determining that the content authorization cache lacks the valid authorization information that authorizes the second content streaming application to access the second content, sending, by the authorization intermediary to the front-end authorization system, information identifying the second content authorization request and the second service provider;
and receiving, by the authorization intermediary from the front-end authorization system, the approval.

11. A computing system, comprising:
one or more computing devices that comprise one or more processors, the one or more processors operable to:
determine, by an authorization intermediary, that a first content streaming application executing on a first content streaming device has been authenticated to access at least a subset of content of a plurality of contents offered by a first service provider;
generate, by the authorization intermediary, a first token that is uniquely associated with the first content streaming application;
send, by the authorization intermediary to the first content streaming application, the first token;
subsequently receive, by the authorization intermediary from the first content streaming application, a first content authorization request to access a first content of the plurality of contents, the first content authorization request including the first token;
determine, by the authorization intermediary, that the first content authorization request is to be granted based on one of a presence of an entry associated with the first content within a content authorization cache maintained by the authorization intermediary and an approval from a front-end authorization system; and
send, by the authorization intermediary to the first content streaming application, information indicating that the first content authorization request has been approved.

12. The computing system of claim 11, wherein the one or more processors are further operable to store, in a data structure, the first token in association with a first content streaming application identifier.

13. The computing system of claim 11, wherein to determine, by the authorization intermediary, that the first content authorization request is to be granted based on one of the presence of the entry associated with the first content within the content authorization cache maintained by the authorization intermediary and the approval from the front-end authorization system, the one or more processors are further operable to:
access, by the authorization intermediary, the content authorization cache;
determine, by the authorization intermediary, that the content authorization cache lacks valid authorization information that authorizes the first content streaming application to access the first content;
in response to determining that the content authorization cache lacks the valid authorization information that authorizes the first content streaming application to access the first content, send, by the authorization intermediary to the front-end authorization system, information identifying the first content authorization request; and
receive, by the authorization intermediary from the front-end authorization system, the approval.

14. The computing system of claim 11, wherein the one or more processors are further operable to:
store, by the authorization intermediary in the content authorization cache, authorization information that authorizes the first content streaming application to access the first content;
subsequently receive, by the authorization intermediary from the first content streaming application, a second content authorization request to access the first content, the second content authorization request including the first token;
access, by the authorization intermediary, the content authorization cache; and
determine, based on the authorization information that authorizes the first content streaming application to access the first content, that the first content streaming application is authorized to access the first content.

15. The computing system of claim 11, wherein the one or more processors are further operable to:
prior to determining, by the authorization intermediary, that the first content authorization request is to be granted based on one of the presence of the entry associated with the first content within the content authorization cache maintained by the authorization intermediary and the approval from the front-end authorization system, validate, by the authorization intermediary, the first token to determine that the first token is a valid token.

16. A non-transitory computer-readable storage medium that includes executable instructions operable to cause one or more processors of one or more computing devices to:
determine, by an authorization intermediary, that a first content streaming application executing on a first content streaming device has been authenticated to access at least a subset of content of a plurality of contents offered by a first service provider;
generate, by the authorization intermediary, a first token that is uniquely associated with the first content streaming application;
send, by the authorization intermediary to the first content streaming application, the first token;
subsequently receive, by the authorization intermediary from the first content streaming application, a first content authorization request to access a first content of the plurality of contents, the first content authorization request including the first token;
determine, by the authorization intermediary, that the first content authorization request is to be granted based on one of a presence of an entry associated with the first content within a content authorization cache maintained by the authorization intermediary and an approval from a front-end authorization system; and
send, by the authorization intermediary to the first content streaming application, information indicating that the first content authorization request has been approved.

17. The non-transitory computer-readable storage medium of claim 16, wherein the instructions are further operable to cause the one or more processors to store, in a data structure, the first token in association with a first content streaming application identifier.

18. The non-transitory computer-readable storage medium of claim 16, wherein to determine, by the authorization intermediary, that the first content authorization request is to be granted based on one of the presence of the entry associated with the first content within the content authorization cache maintained by the authorization intermediary and the approval from the front-end authorization system, the instructions are further operable to cause the one or more processors to:
access, by the authorization intermediary, the content authorization cache;
determine, by the authorization intermediary, that the content authorization cache lacks valid authorization information that authorizes the first content streaming application to access the first content;
in response to determining that the content authorization cache lacks the valid authorization information that authorizes the first content streaming application to access the first content, send, by the authorization intermediary to the front-end authorization system, information identifying the first content authorization request; and
receive, by the authorization intermediary from the front-end authorization system, the approval.

19. The non-transitory computer-readable storage medium of claim 16, wherein the instructions are further operable to cause the one or more processors to:store, by the authorization intermediary in the content authorization cache, authorization information that authorizes the first content streaming application to access the first content;subsequently receive, by the authorization intermediary from the first content streaming application, a second content authorization request to access the first content, the second content authorization request including the first token;access, by the authorization intermediary, the content authorization cache; anddetermine, based on the authorization information that authorizes the first content streaming application to access the first content, that the first content streaming application is authorized to access the first content.

20. The non-transitory computer-readable storage medium of claim 16, wherein the instructions are further operable to cause the one or more processors to:
prior to determining, by the authorization intermediary, that the first content authorization request is to be granted based on one of the presence of the entry associated with the first content within the content authorization cache maintained by the authorization intermediary and the approval from the front-end authorization system, validate, by the authorization intermediary, the first token to determine that the first token is a valid token.
